(19) United States
(12) Patent Application Publication
(10) Pub. No.: US 2019/0339535 A1
(43) Pub. Date: Nov. 7, 2019

(54) AUTOMATIC EYE BOX ADJUSTMENT

(71) Applicant: Visteon Global Technologies, Inc., Van Buren Township, MI (US)

(72) Inventors: Elie Abi-Chaaya, Jouy le Moutier (FR); Benoit Chauveau, Mery Sur Oise (FR); Vincent Portet, Van Buren Township, MI (US); Laurent Delrocq, Van Buren Township, MI (US)

(73) Assignee: Visteon Global Technologies, Inc., Van Buren Township, MI (US)

(21) Appl. No.: 16/475,273

(22) PCT Filed: Jan. 2, 2018
(86) PCT No.: PCT/US2018/012026

§ 371 Date: Jul. 1, 2019

Related U.S. Application Data
(60) Provisional application No. 62/441,545, filed on Jan. 2, 2017.

(51) Int. Cl. G02B 27/01; B60R 1/00; B60K 35/00

(52) U.S. Cl. CPC G02B 27/0179; G02B 2027/0138; B60K 35/00; G02B 27/0101; B60R 2300/205; B60R 2300/301; B60R 2300/60; B60K 2370/1529; B60K 2370/167; B60K 2370/193; B60K 2370/52; G02B 2027/014; G02B 2027/0183; G02B 2027/0141; G02B 2027/0181; B60R 1/00

(57) ABSTRACT

The aspects disclosed herein are related to systems, methods, and devices to perform automatic eye box adjustments (for example, those that are implemented in a heads-up display context) for a vehicle-based implementation. The aspects disclosed herein employ either detection of a viewer's eye location, height, position, or a combination thereof to perform said eye box adjustment. Various aspects disclosed herein may also be directed to also adjusting graphical assets (for example, augmented reality content) used in the context of said HUD implementation.

### CROSS REFERENCE TO RELATED APPLICATION

This PCT International Patent Application claims the benefit of U.S. Provisional Patent Application Ser. No. 62/441,545 filed on Jan. 2, 2017, the entire disclosure of this application being considered part of the disclosure of this application, and hereby incorporated by reference.

### BACKGROUND

Displays are employed to convey digital information via a lighted platform. The displays are installed in a variety of contexts and environments, such as televisions, advertisements, personal computing devices, and more commonly in recent times, in vehicles.

The standard display assembly includes display driving logic with various instructions as to the patterns to communicate to an array of lighting elements. The display driving logic communicates signals that instruct which of the lighting elements to light up, and a corresponding intensity and color (if available). The display assembly may be incorporated with various interface devices, such as keyboards, pointers, gaze trackers, head trackers, eye trackers, touch screens, and the like.

The displays are usually cased with transparent substances, such as lenses, that allow light being illuminated to be projected to the viewer's eyes. A surface of the lens faces the viewer of the display, and thus, implementers provide different shapes, sizes, and types based on an implementers preference. Further, different locations and such may necessitate the lens to be a specific type and shape.

In recent years, displays in vehicles have been employed using heads-up displays (HUD). A HUD is a display intended to be in front of a viewer (for example the windscreen area of a vehicle), that allows the viewer to see content on the windscreen and still see the area on the other side of a transparent glass.

FIG. 1 illustrates a prior art implementation of a HUD. As shown, the HUD has an optical system 110 that projects information onto the windscreen 100. The optical system 110 is known, and thus, a detailed description will be omitted. The image is projected at a virtual image 120 location as shown, and is optimized by a viewer's eye box 130. The eye box 130 is an area associated with the viewer that corresponds to where the viewer's eye is, and as such, the image projected from the optical system 110 is configured to be projected at the virtual image 120′s location in conjunction with the eye box 130.

### SUMMARY

The following description relates to system, methods, and an automatic eye box adjustment. Exemplary embodiments may also be directed to any of the system, the method, or an applications implementing said eye box adjustment for a heads-up display (HUD).

Additional features of the invention will be set forth in the description which follows, and in part will be apparent from the description, or may be learned by practice of the invention.

The aspects disclosed herein are related to systems, methods, and devices to perform automatic eye box adjustments (for example, those that are implemented in a heads-up display context) for a vehicle-based implementation. The aspects disclosed herein employ either detection of a viewer's eye location, height, position, or a combination thereof to perform said eye box adjustment. Various aspects disclosed herein may also be directed to also adjusting graphical assets (for example, augmented reality content) used in the context of said HUD implementation.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates a prior art implementation of a HUD;

FIG. 2 illustrates a prior art implementation of adjusting a HUD;

FIG. 3 illustrates an eye box adjustment diagram;

FIG. 4 illustrates a first embodiment of a system for automatic eye box adjustment disclosed herein;

FIGS. 5(a) and 5(b) illustrate an examples of methods employing exemplary aspects disclosed herein;

FIG. 6 illustrates a high-level diagram for implementing the aspects shown in FIGS. 4 and 5(a);

FIGS. 7(a) and 7(b) illustrate the employment of an image capturing device 400 according to the aspects disclosed herein;

FIG. 8 illustrates a variety of locations in which the image capturing device may be situated in a vehicular context;

FIG. 9 illustrates a second embodiment employing the aspects disclosed herein;

FIG. 10 illustrates a phenomenon that necessitates the systems disclosed herein;

FIG. 11 illustrates a third embodiment of the aspects disclosed herein;

FIG. 12 illustrates a problem with implementing augmented reality (i.e., the placement of virtual objects) with the aspects disclosed above with regards to the first and second embodiment;

FIG. 13 addresses this issue by employing the aspects disclosed herein with regards to the third embodiment; and

FIG. 14 illustrates a system-level diagram illustrating how the advantages according to the third embodiment are achieved according to the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, HUD implementations in the vehicle are becoming more commonplace. However, the standard HUD is based on a premise of a one-size fits-all model. Thus, the reality and variation of viewers (i.e. drivers, occupants, passengers, or any individual situation in the vehicle while the vehicle is in operation or not in operation), frustrates the implementation of the HUD.

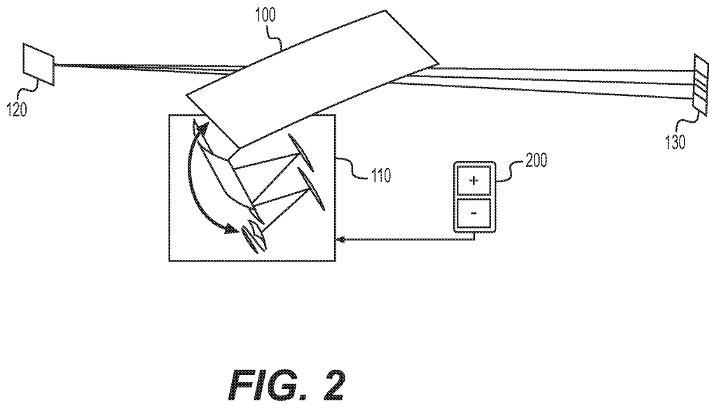

As shown in FIG. 2, various manual devices have been provided to solve this issue. However, this requires a viewer to manually adjust the HUD (via toggle switch 200). Toggle switch 200 manually adjusts a reflective plate up and down based on a user's preference. If various viewers are using the HUD or the vehicle, this task of manual adjustment may become difficult. Further, on long car trips where a driver may slouch, the HUD's alignment may become out of focus.

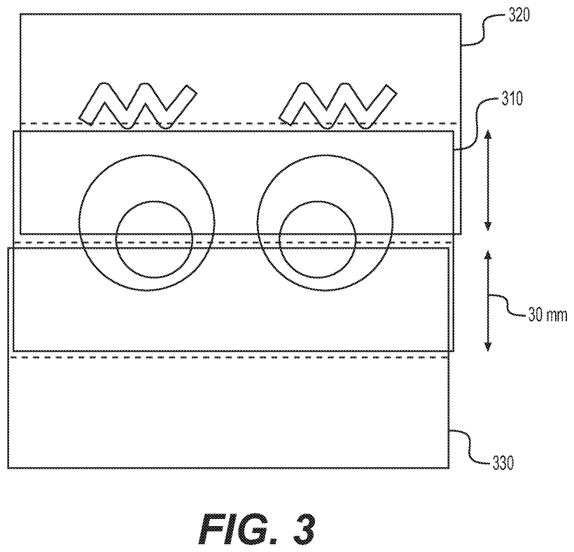

As shown in FIG. 3, the eye box 130 may occupy a standard location 310, a higher location 320, or a lower location 330 based on the operation of switch 200.

Disclosed herein are methods and systems for automatic eye box adjustment. The methods and systems disclosed herein may employ a variety of devices and sensors already situated in a vehicle implementation. The aspects disclosed herein discuss techniques of employing these devices and sensors to provide an ultimately improved HUD experience in a vehicular context.

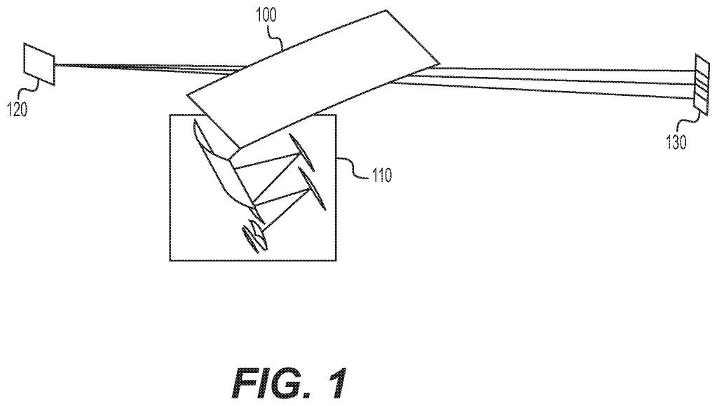

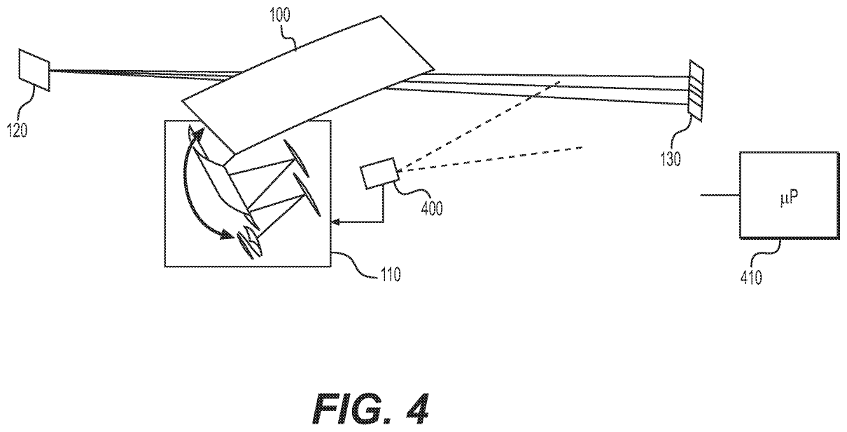

FIG. 4 illustrates a first embodiment of a system for automatic eye box adjustment disclosed herein. As shown in FIG. 4, the aspects/elements disclosed are similar to those shown in FIG. 1. However, additionally shown is an image capturing device 400. An image capturing device 400 is oriented in a direction of the viewer of the windscreen 100, and specifically is configured to capture the eye box 130 area as shown. As the implementation is in a vehicle, the system shown in FIG. 4 may incorporate either gaze tracking device, a head tracking device, or some other image capturing device situated in a vehicle provided for another function other than augmenting the control of the an optical system 110 of the HUD.

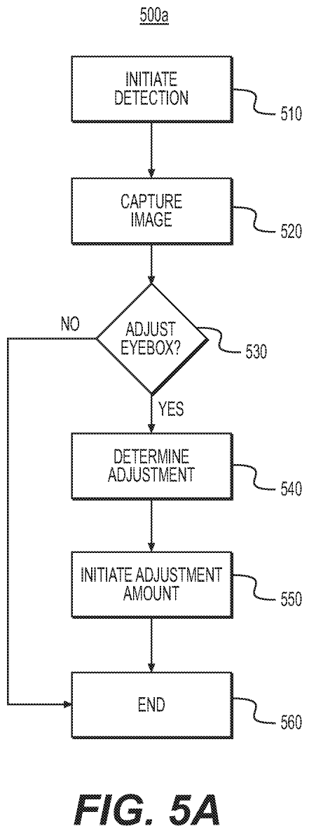

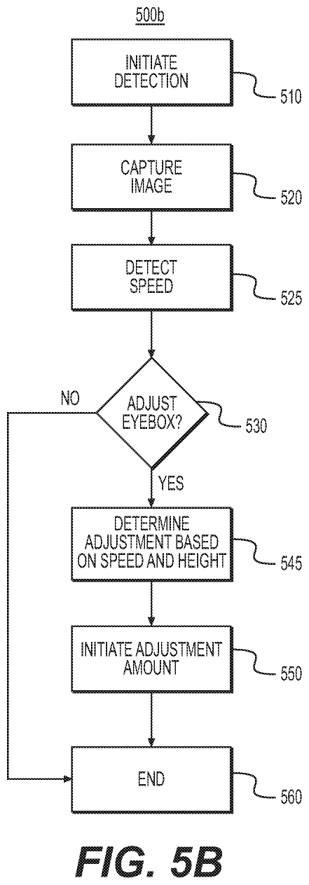

The image capturing device 400 captures an image of the viewer, and propagates the image data to a microprocessor 410. FIG. 5(a) illustrates a method 500 for configuring the microprocessor 410 according to the aspects disclosed herein. A microprocessor 410 may be pre-installed with the instructions shown in FIGS. 5(a) and 5(b), or a microprocessor already situated in a vehicle (such as a centralized electronic control unit) may be modified to incorporate the instructions shown in FIG. 5(a).

In operation 510, a signal instigating the aspects disclosed herein is received. The method 500 may be instigated through a variety of ways and stimuli, or a combination thereof. For example, the method 500 may perform at a predetermined time interval. Alternatively, a signal associated with the vehicle may instigate the method 500 to commence operation, for example, turning on the car, turning on the HUD, entering the car, a motion detector detecting a vehicle, or even just a touch or command indicating adjustment to occur.

In operation 520, the microprocessor 410 propagates a command to the image capturing device 400 to capture an image of the viewer (and specifically an area of the viewer associated with the eye box 130). The microprocessor 410 may alternatively be provided with an algorithm or technique to ensure that a valid eye box 130 containing photo is capture.

Alternatively to operation 520, the image captured may be employed to determine the height of the subject being captured. Once a height is obtained, an estimated location of the eye box 130 area may be calculated for the purposes of executing method 500.

In operation 530, a determination is made as to whether the captured eye box 130 is in a predetermined area or threshold associated with the current HUD configuration. If it is, the determination in operation 530 is made as no adjustment needed, and the method 500 proceeds to end 560. Alternatively, if the method 500 determines that an adjustment is needed, the method 500 proceeds to operation 540.

In operation 540, the determined adjustment amount is calculated. A lookup table may be employed to correlate the ascertained or captured location of the eye box relative to the current (or standard) orientation of the eye box 130. Accordingly, the amount associated with the movement of the HUD is made.

In operation 550, a HUD's eye box 130 is moved either up or down to adjust to the location of the ascertained/capture eye box 130. After which, the method 500 proceeds to END 560.

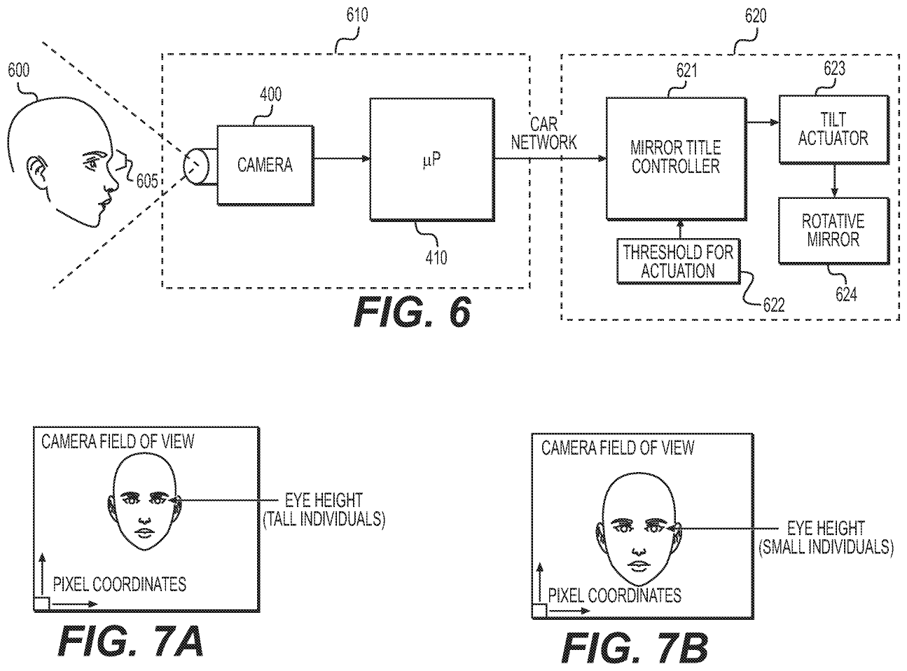

FIG. 6 illustrates a high-level diagram for implementing the aspects shown in FIGS. 4 and 5(a). As shown, a portion 610 includes an image capturing device 400 electrically coupled to a microprocessor 410.

As shown, employing the steps shown in FIG. 5(a), a decision to tilt the mirror is sent via the vehicle network to an optical system 110 (certain elements of the optical system 110 are shown as 620 in FIG. 6). If the amount to adjust is over a threshold of actuation 622, a tilt actuator 623 is controlled via the mirror tilt controller 621. The tilt actuator 623 adjusts the rotative mirror 624 in an up and down orientation, thereby adjusting the eye box 130 for a viewer 600 shown. The rotative mirror 624 is configured to display the virtual image 120 in a manner to optimize the current location of the eye box 130.

As such, the viewer 600, with eyes 605 (with a corresponding eye box location), are aligned with the presentation of information from the optical system 110 described herein. This alignment is accomplished via an automatic adjustment employing the aspects disclosed herein.

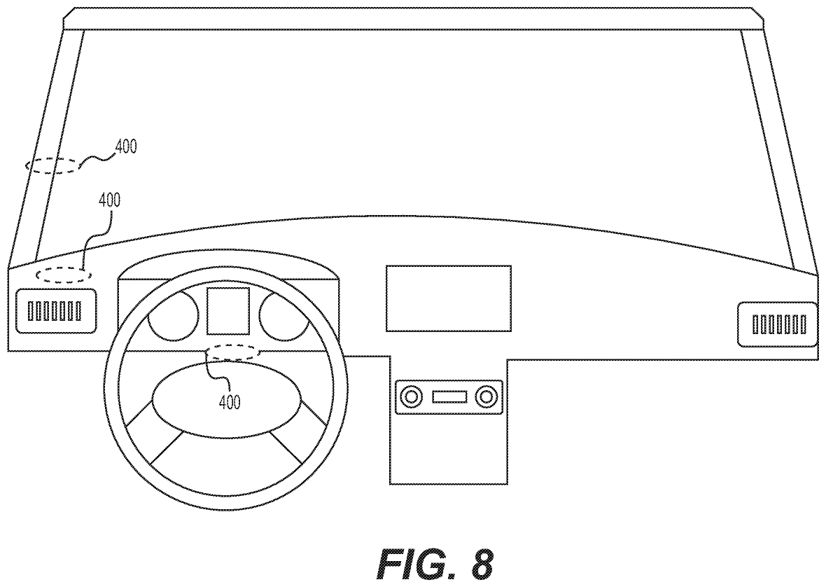

FIGS. 7(a) and 7(b) illustrate the employment of an image capturing device 400 according to the aspects disclosed herein. The camera 400 captures the height of an individual relative to their view of the HUD windscreen 100 and virtual image 120. In FIG. 7(a), the camera detects an individual is tall, and in FIG. 7(b), the camera detects the individual is shorter. Accordingly, the eye box 130 may be individually and automatically customized for each viewer.

FIG. 8 illustrates a variety of locations in which the image capturing device 400 may be situated in a vehicular context. As shown, the image capturing device 400 may be located in the vehicle cockpit (behind the steering wheel), embedded in the dashboard, or part of the windscreen 100. These locations are exemplary, and other locations may also be employed.

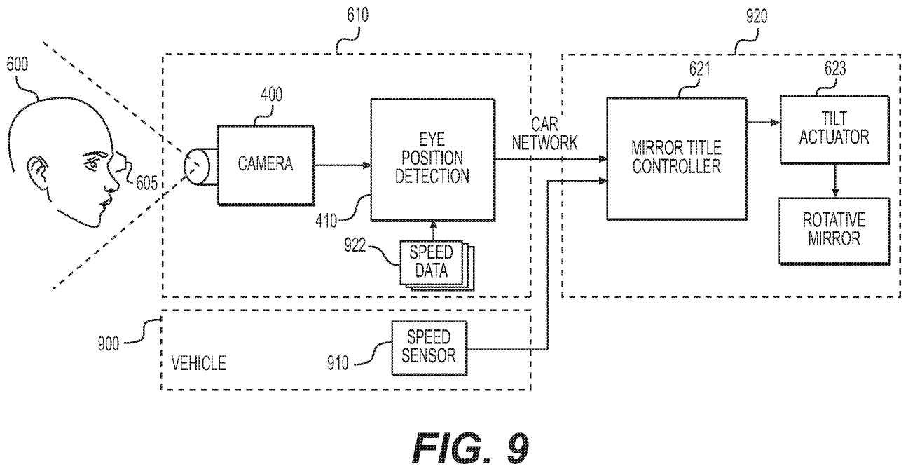

FIG. 9 illustrates a second embodiment employing the aspects disclosed herein. As shown, nearly everything is similar, except a few modified instructions are included in the microprocessor 410. These modifications are detailed in FIG. 5(b), a described with method 500b. Additionally, the optical system 130 (now shown as implementation 920) is additionally coupled to a speed sensor 910 implemented on a vehicle 900. The speed sensor 910 propagates speed data 922 to the microprocessor 410.

As shown in FIG. 5(b), an additional step 525 is added, which takes into account the present speed of the vehicle (via speed data 922). As such, when a determination about adjustment is made (in operation 545), the determination includes both the detected eye location (or height of the viewer), and the speed of the vehicle 900.

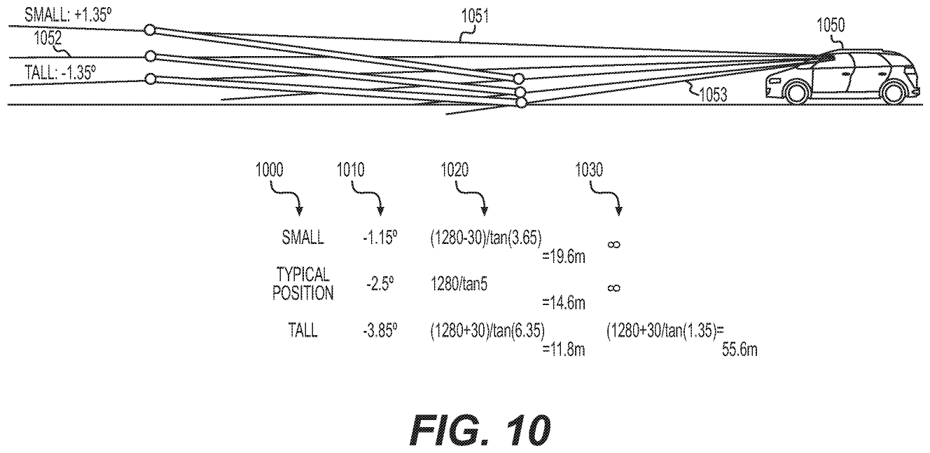

FIG. 10 illustrates this phenomena with greater detail. As shown, there are three distinct locations for where a virtual image may be for a: shorter viewer (or small) 1051, an average height viewer 1052, and a taller viewer 1053. Additionally, each passenger potentially located in vehicle 1050 may have three potential locations of the image (as adjusted via the eye box 130) based on detected speed. Table 1000 illustrates an example of an algorithm for employing the detected angle and virtual image location.

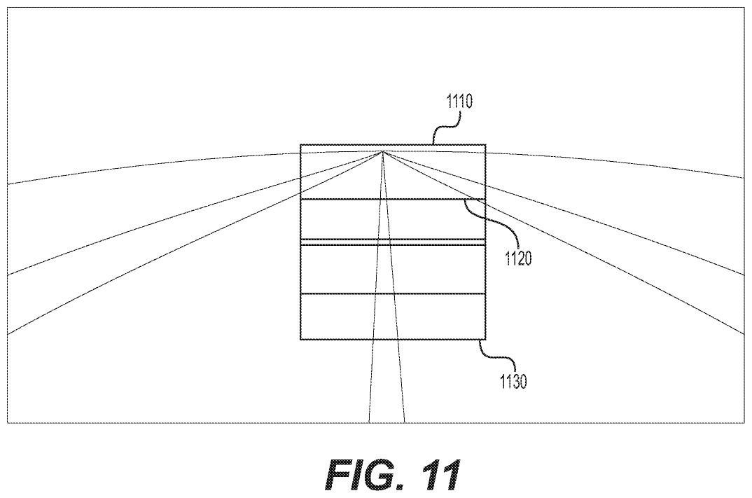

FIG. 11 illustrates a third embodiment of the aspects disclosed herein. As explained, the eye box 130 may be adjusted by a combination of the aspects disclosed above with regards to the first and second embodiment.

Certain HUD implementations are also provided with augmented reality. Augmented reality is a modification of virtual reality, that highlights detected objects in a manner so as to provide graphical user interfaces via real-world seen objects.

In FIG. 11, the eye box 130 may be configured to move up or down to have a window 1110, 1120, and 1130. Objects located in the windows are highlighted for augment reality purposes.

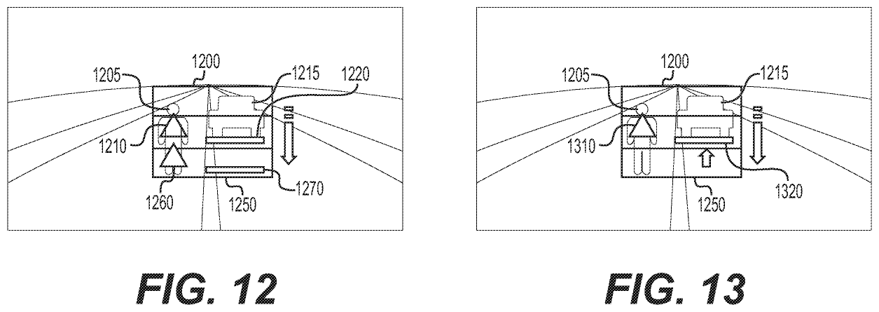

FIG. 12 illustrates a problem with implementing augmented reality (i.e. the placement of virtual objects) with the aspects disclosed above with regards to the first and second embodiment. In a first virtual window 1200, the virtual objects 1210 and 1220 are used to highlight real world objects 1205 and 1215. As the virtual window 1200 is moved down (to a location such as 1250, via, for example, an automatic eye box adjustment disclosed herein), the virtual objects 1210 and 1220 also move down, thereby occupying space 1260 and 1270. As such, the virtual objects in the new location no longer correspond or overlap to the real world objects intended to be augmented or highlighted.

FIG. 13 addresses this issue by employing the aspects disclosed herein with regards to the third embodiment. Specifically, FIG. 13 maintains virtual object 1310 and 1320 over real world objects 1205 and 1215 even as the HUD is adjusted to move the virtual window 1200 to a new location 1250.

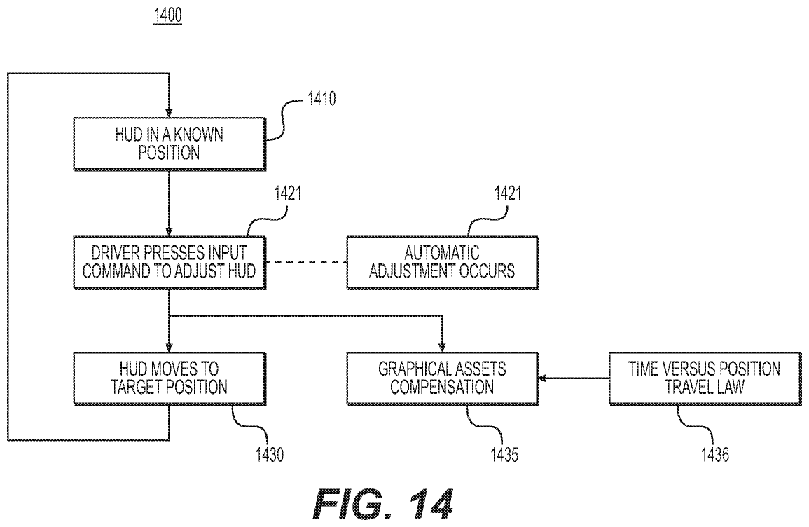

FIG. 14 illustrates a system-level diagram illustrating how the advantages according to the third embodiment are achieved according to the aspects disclosed herein.

In operation 1410, the HUD is in a default or initial position. In operation 1421, a driver either asserts a command to move/adjust the HUD (or it automatically occurs). As such, in operation 1430, the HUD moves to the new target position based on the above-noted adjustment. In operation 1435 and 1436, the augmentation previously performed in operation 1410 is compensated for the movement (and additionally for any distance traveled by the vehicle during the adjustment).

Thus, according the system shown in FIG. 14, a HUD implementation successfully renders virtual/augmented information while allowing for manual/automatic adjustment of a HUD's eye box and/or virtual window.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for automatic eye box adjustment for a heads-up display (HUD), comprising:
a data store comprising a non-transitory computer readable medium storing a program of instructions for the managing of the alert;
a processor that executes the program of instructions, the instruction comprising the following steps:
capturing an image of a viewer of the HUD;
determining whether an adjustment of the eye box is necessary;
in response to the determination being necessary, determining an adjustment amount for the eye box based on the captured image of the viewer; and
performing the automatic eye box adjustment based on the determined adjustment amount.

2. The system according to claim 1, further comprising a step of initiating the program of instructions based on a stimulus.

3. The system according to claim 2, wherein the stimulus is defined as turning on a vehicle in which the HUD is implemented in.

4. The system according to claim 2, wherein the stimulus is defined as an indication from a user.

5. The system according to claim 2, wherein the stimulus is defined as a detected vibration from a motion detector electrically coupled to the processor.

6. The system according to claim 1, wherein the system is further configured to a receive information based on a detected speed of a vehicle, and the automatic eye box adjustment based on the determined adjustment amount and the detected speed.

7. The system according to claim 1, wherein the system is further configured to adjust augmented reality components displayed via the HUD based on the performed adjustment.

8. The system according to claim 6, wherein the system is further configured to adjust augmented reality components displayed via the HUD based on the performed adjustment.
